(19) United States
(12) Patent Application Publication
(10) Pub. No.: US 2017/0300503 A1
(43) Pub. Date: Oct. 19, 2017

(54) METHOD AND APPARATUS FOR MANAGING VIDEO DATA, TERMINAL, AND SERVER

(71) Applicant: Beijing Xiaomi Mobile Software Co., Ltd., Beijing (CN)

(72) Inventors: Da WANG, Beijing (CN); Yan Xie, Beijing (CN); Yue Cheng, Beijing (CN)

(73) Assignee: Beijing Xiaomi Mobile Software Co., Ltd.

(21) Appl. No.: 15/486,723

(22) Filed: Apr. 13, 2017

(30) Foreign Application Priority Data
Apr. 15, 2016 (CN) 201610237291.5

(51) Int. Cl. G06F 17/30; H04L 29/08; H04N 5/77

(52) U.S. Cl. CPC G06F 17/3082; H04N 5/77; G06F 17/30858; G06F 17/3087; H04L 67/327

(57) ABSTRACT

A method for managing video data, includes: detecting whether an accident happens to a first vehicle; when it is detected that the accident happens to the first vehicle, sending to a server a first request for acquiring first video data, the first video data being driving record data of a second vehicle within a predetermined time period around happening of the accident, the second vehicle being a vehicle within a predetermined range around the first vehicle when the accident happens; and receiving the first video data returned from the server.

### CROSS-REFERENCE TO RELATED APPLICATIONS

This application is based upon and claims priority to Chinese Patent Application No. CN 201610237291.5, filed on Apr. 15, 2016, the entire contents of which are incorporated herein by reference.

### TECHNICAL FIELD

The present disclosure relates to the field of terminal technologies, and more particularly, to a method and an apparatus for managing video data, a terminal, and a server.

### BACKGROUND

With the development of technologies, vehicles become increasingly advanced and convenient for people's travel. Today, the automobile is probably the most important vehicle for people's daily life. A user may install a video recorder in the user's own car, also known as a car recorder or a driving recorder, for supporting evidence in case of a traffic accident. However, sometimes it may be difficult to identify a cause of the traffic accident only through video data collected by the video recorder of the user's own car in the traffic accident, thereby requiring more videos from other visual angles for multi-orientational analysis. But finding vehicles passing by as the traffic accident happens is typically difficult. Therefore, it is difficult to acquire video data collected by video recorders of those vehicles, resulting in waste of a large quantity of video data that may be helpful for investigating the traffic accident, thereby reducing effective usage of the car recorders.

### SUMMARY

According to a first aspect of the present disclosure, there is provided a method for managing video data, comprising: detecting whether an accident happens to a first vehicle; when it is detected that the accident happens to the first vehicle, sending to a server a first request for acquiring first video data, the first video data being driving record data of a second vehicle within a predetermined time period around happening of the accident, the second vehicle being a vehicle within a predetermined range around the first vehicle when the accident happens; and receiving the first video data returned from the server.

According to a second aspect of the present disclosure, there is provided a method for managing video data, comprising: receiving, from a first terminal corresponding to a first vehicle, a first request for acquiring first video data; acquiring, as the first video data, driving record data of a second vehicle within a predetermined time period around happening of an accident, the second vehicle being a vehicle within a predetermined range around the first vehicle when the accident happens; and returning the first video data to the first terminal.

According to a third aspect of the present disclosure, there is provided a terminal, comprising: a processor; a memory for storing instructions executable by the processor; wherein the processor is configured to: detect whether an accident happens to a first vehicle; when it is detected that the accident happens to the first vehicle, send to a server a first request for acquiring first video data, the first video data being driving record data of a second vehicle within a predetermined time period around happening of the accident, the second vehicle being a vehicle within a predetermined range around the first vehicle when the accident happens; and receive the first video data returned from the server.

According to a fourth aspect of the present disclosure, there is provided a server, comprising: a processor; a memory for storing instructions executable by the processor; wherein the processor is configured to: receive, from a first terminal corresponding to a first vehicle, a first request for acquiring first video data; acquire, as the first video data, driving record data of a second vehicle within a predetermined time period around happening of the accident, the second vehicle being a vehicle within a predetermined range around the first vehicle when the accident happens; and return the first video data to the first terminal.

It is to be understood that both the foregoing general description and the following detailed description are exemplary and explanatory only and are not restrictive of the present disclosure, as claimed.

### BRIEF DESCRIPTION OF THE DRAWINGS

The accompanying drawings herein, which are incorporated into and constitute a part of the specification, illustrate embodiments consistent with the present disclosure, and together with the description, serve to explain the principles of the present disclosure.

FIG. 1 is a schematic diagram of a system for managing video data according to an exemplary embodiment.

FIG. 2 is a flowchart of a method for managing video data according to an exemplary embodiment.

FIG. 3A is a flowchart of a method for managing video data according to another exemplary embodiment.

FIG. 3B is a scenario diagram for methods for video data management according to an exemplary embodiment.

FIG. 4 is a block diagram of an apparatus for managing video data according to an exemplary embodiment.

FIG. 5 is a block diagram of a detection module according to another exemplary embodiment.

FIG. 6 is a block diagram of an acquiring sub-module according to another exemplary embodiment.

FIG. 7 is a block diagram of an apparatus for managing video data according to another exemplary embodiment.

FIG. 8 is a block diagram of an apparatus for managing video data according to another exemplary embodiment.

FIG. 9 is a block diagram of an acquiring module according to another exemplary embodiment.

FIG. 10 is a block diagram of an apparatus for managing video data according to another exemplary embodiment.

FIG. 11 is a block diagram of an apparatus for managing video data according to another exemplary embodiment.

FIG. 12 is a block diagram of an apparatus for managing video data according to another exemplary embodiment.

FIG. 13 is a block diagram of an apparatus for managing video data according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of apparatuses and methods consistent with aspects related to the present disclosure as recited in the appended claims.

The terminology used in the present disclosure is for the purpose of describing particular embodiments only and is not intended to limit the present disclosure. As used in the present disclosure and the appended claims, the singular forms “a”, “an” and “the” are intended to include the plural forms as well, unless the context clearly indicates otherwise.

It shall be understood that, although the terms “first”, “second”, etc. may be used herein to describe various information, the information should not be limited by these terms. These terms are only used to distinguish one category of information from another. For example, without departing from the scope of the present disclosure, first information may be termed as second information; and similarly, second information may also be termed as first information. As used herein, the term “if” may be understood to mean “when” or “upon” or “in response to determining” depending on the context.

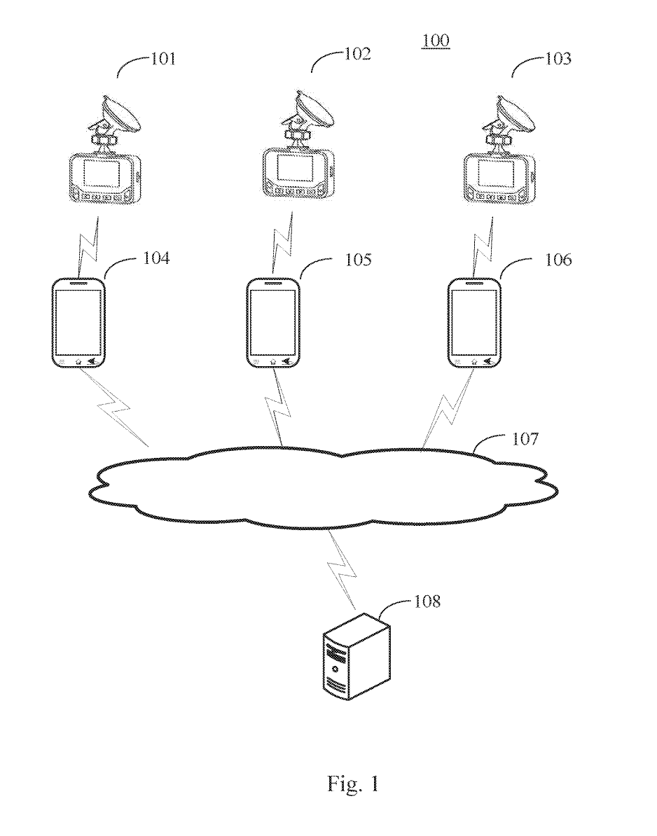

FIG. 1 is a schematic diagram of a system 100 for managing video data according to an exemplary embodiment. For example, as shown in FIG. 1, the system 100 includes driving recorders 101, 102, and 103, terminals 104, 105, and 106, a network 107, and a server 108.

The driving recorders 101, 102, and 103 are configured to collect driving record data, and may communicate with the terminals 104, 105, and 106, respectively, by Bluetooth, infrared, WiFi, Near Field Communication (NFC) or the like, so as to receive or send a request or information and the like.

The network 107 is configured to provide a communication link between each of the terminals 104, 105, and 106 and the server 108. The network 107 may include various types of connection such as a wired communication link, a wireless communication link, a fiber optic cable and the like.

By the network 107, the terminals 104, 105, and 106 may interact with the server 108 to receive or send a request or information and the like. The terminals 104, 105, and 106 may be various kinds of electronic apparatus, which include but are not limit to mobile terminals, smart phones, smart wearable devices, tablet computers, personal digital assistants and the like. The server 108 may be a server which provides various kinds of services. Also, the server 108 may process (such as store, analyze and the like) received data and feed a result back to a terminal. The server may respond to a request of a user to provide a service. It is understood that the server 108 may provide one or more kinds of services, and one service may be provided by one or more servers.

It shall be understood that the number of driving recorders, the number of terminals, the number of networks, and the number of servers are for the illustrative purpose only. The system 100 may include any number of driving recorders, terminals, networks, and servers based on actual demand.

In one exemplary embodiment, the terminals 104, 105, and 106 detect whether an accident happens to a vehicle which contains the terminals 104, 105, and 106, respectively. For example, when the terminal 104 detects that an accident happens to a first vehicle which contains the terminal 104, by the network 107, the terminal 104 may send to the server 108 a request for acquiring first video data. The first video data include driving record data of a second vehicle within a predetermined time period around happening of the accident, the second vehicle being within a predetermined range around the first vehicle when the accident happens. The server 108 acquires the first video data stored therein and returns the first video data to the terminal 104. In addition, the terminal 104 may further acquire, from the driving recorder 101 connected with the terminal 104, driving record data within the predetermined time period around happening of the accident as second video data, and sends the second video data to the server 108 by the network 107 so that the server 108 stores the second video data.

The terminals 104, 105, and 106 and the server 108 are configured to perform methods for managing video data, as described in detail below.

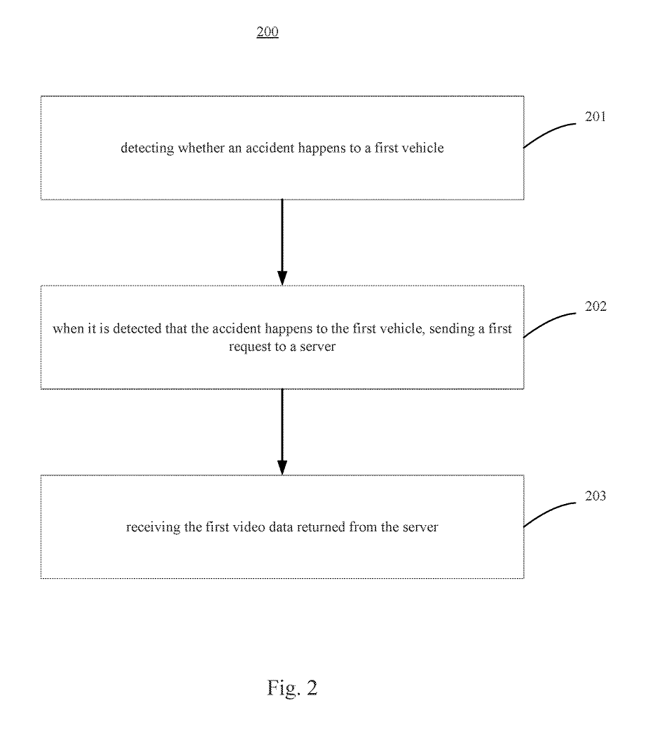

FIG. 2 is a flowchart of a method 200 for managing video data according to an exemplary embodiment. The method 200 may be applied to a terminal, such as a mobile terminal, a smart phone, a smart wearable device, a tablet computer, a personal digital assistant and the like. Referring to FIG. 2, the method 200 includes the following steps.

In step 201, the terminal detects whether an accident happens to a first vehicle corresponding to the terminal.

In the exemplary embodiment, the terminal has a communication connection with a car recorder installed in the first vehicle, and detects whether an accident happens to the first vehicle in real time by acquiring driving data of the first vehicle. For example, data collected by a gyro sensor of the terminal may be acquired as the driving data. Also for example, a communication connection is established between the terminal and the first vehicle, and data collected by a sensor installed in the first vehicle is acquired as the driving data, the sensor being configured to detect shock or a driving state of the first vehicle. It shall be understood that the terminal may acquire any other data which reflect the driving state of the first vehicle as the driving data, and the present disclosure is not limited to a specific form of the driving data and the way of acquiring the driving data.

The terminal may then detect whether an abnormality occurs in the driving data. If an abnormality occurs in the driving data, the terminal determines that the accident happens to the first vehicle. Generally speaking, when an accident happens, an acceleration of a vehicle changes significantly, such as a magnitude of the acceleration or a direction of the acceleration changes significantly, which may be used to detect the occurrence of an accident. For example, assuming that data collected by the gyro sensor of the terminal is acquired as the driving data, the terminal can process the data to obtain accelerations of the first vehicle in all directions, and subsequently analyze the data by a preset accident data characteristic model or a preset rule to determine whether an abnormality occurs in the driving data. If the acceleration changes significantly, such as a magnitude of the acceleration in a direction exceeding a preset limitation or a direction of the acceleration changes a large number of degrees suddenly, the terminal determines an abnormality occurs in the driving data.

On the other hand, when an accident happens, a strong shock may happen to a vehicle, which may also be used to detect the occurrence of an accident. For example, assuming that data collected by the sensor installed in the vehicle is acquired as the driving data, the terminal may analyze the data to determine whether a strong shock happens to the first vehicle. If a strong shock happens to the first vehicle, the terminal determines that an accident happens to the first vehicle.

In step 202, when it is detected that the accident happens to the first vehicle, the terminal sends a first request to a server.

In the exemplary embodiment, the first request is for acquiring first video data, and the first video data includes driving record data of a second vehicle within a predetermined time period around happening of the accident, and the second vehicle is a vehicle within a predetermined range around the first vehicle when the accident happens.

To have a multi-orientational analysis for a cause of the accident, besides the driving data of the first vehicle to which the accident happens, the terminal obtains driving data collected from other angles. The driving data may include video data collected by a car recorder of the second vehicle. When the accident happens to the first vehicle, the second vehicle within the predetermined range around the first vehicle may collect video data which is relevant to the accident. Thereby, after the accident happens to the first vehicle, the terminal obtains the driving record data collected by the second vehicle within the predetermined range around the first vehicle.

In the exemplary embodiment, the predetermined time period may be any reasonable time period. For example, it may start from three minutes or one minute before the accident and may end three minutes or one minute after the accident. Also, it may start from one minute before the accident and may end two minutes after the accident. The present disclosure does not limit the predetermined time period.

In the exemplary embodiment, the predetermined range may be any reasonable range. The predetermined range includes a location of the first vehicle where the accident happens. For example, the range may be a circular scope which is centered on the location where the accident happens to the first vehicle and have a 20-meter radius. Also for example, the range may be centered on the location where the accident happens to the first vehicle and have a rectangular scope with a length of 20 meters. As another example, the range may be centered on the location where the accident happens to the first vehicle and covers a 20-meter long road. The present disclosure does not limit the predetermined range.

In the exemplary embodiment, the first request may include information of the first vehicle, including the location and a time at which the accident happens to the first vehicle, so as to search for a second vehicle according to the information of the first vehicle and acquire driving record data of the second vehicle as the first video data.

In step 203, the terminal receives the first video data returned from the server.

In the exemplary embodiment, after acquiring the first video data, the server sends the first video data to the terminal corresponding to the first vehicle to which the accident happens.

According to the method 200, when it is detected that the accident happens to the first vehicle, the terminal acquires, from the server, driving record data of the second vehicle within the predetermined time period around happening of the accident, and the second vehicle is a vehicle within the predetermined range around the first vehicle when the accident happens. Accordingly, the terminal obtains additional accident-related video data collected by the car recorder of the second vehicle, thereby increasing effective usage of car recorders.

In some embodiments, the method 200 further includes acquiring, as second video data, driving record data of the first vehicle within a predetermined time period around happening of the accident; and sending the second video data to the server to be stored therein. The predetermined time period corresponding to the second video data may be the same as, or different from, the predetermined time period corresponding to the first video data, which is not limited in the present disclosure.

The second video data collected by a car recorder installed in the first vehicle to which the accident happens may be important data as well. Accordingly, in the embodiments, driving record data of the first vehicle within the predetermined time period around happening of the accident may be acquired as the second video data and be sent to the server. Meanwhile, the information of the first vehicle, including the location and the time at which the accident happens, may be sent to the server so that the server can store the second video data as corresponding to the above information.

In the exemplary embodiment, by Bluetooth, infrared, WiFi and the like, the terminal corresponding to the first vehicle may establish a communication connection with the car recorder installed in the first vehicle, and sends a video acquiring request which includes a start time and an end time of the predetermined time period. After the car recorder of the first vehicle receives the acquiring video request, the car recorder acquires video data collected in this time period, as the second video data, according to the start time and the end time of the predetermined time period. And the second video data is sent to the terminal and subsequently is sent by the terminal to the server.

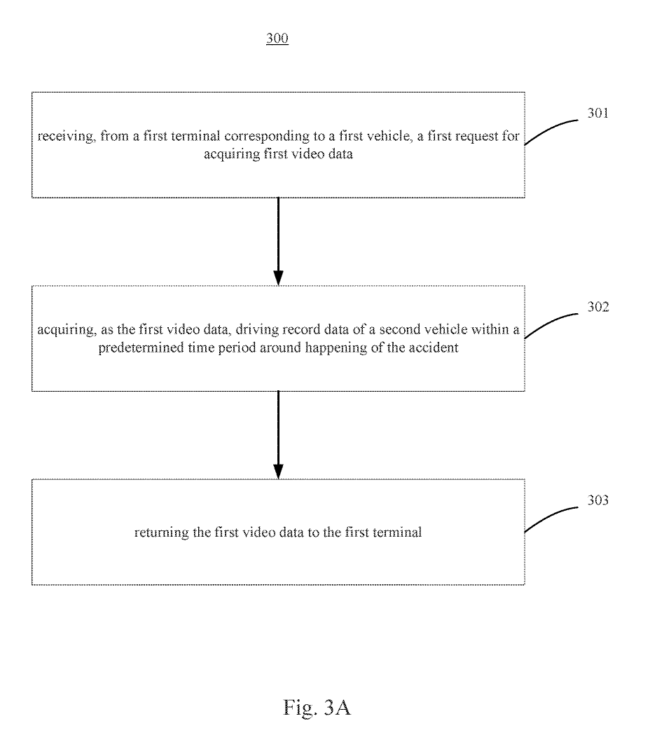

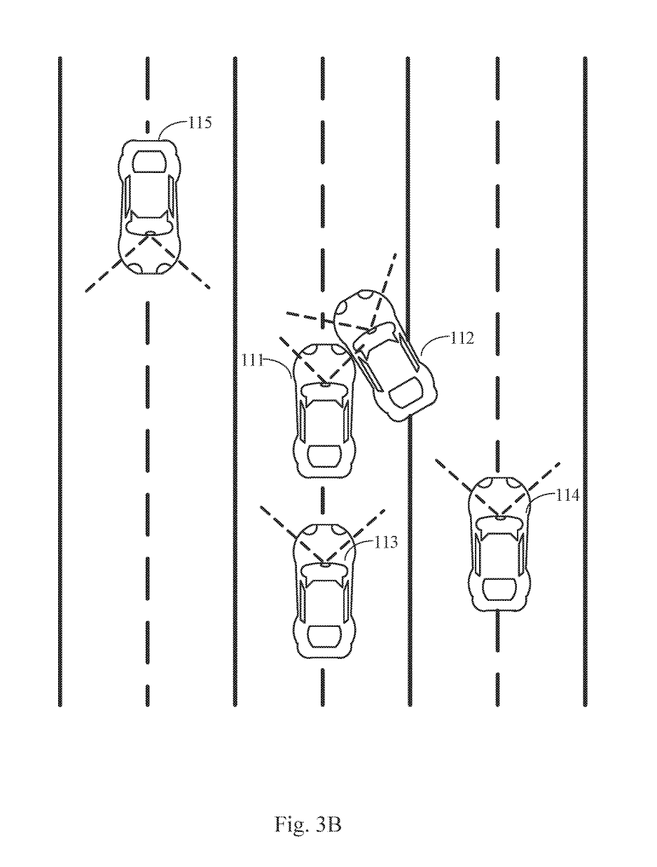

FIG. 3A is a flowchart of a method 300 for managing video data according to another exemplary embodiment. For example, the method 300 may be applied to a server. Referring to FIG. 3A, the method 300 includes the following steps.

In step 301, the server receives, from a first terminal corresponding to a first vehicle, a first request for acquiring first video data.

In the exemplary embodiment, the first terminal corresponding to the first vehicle establishes a communication connection with a car recorder installed in the first vehicle. After an accident happens to the first vehicle, the first terminal sends to the server the first request for acquiring the first video data. The first video data includes driving record data of a second vehicle within a predetermined time period around happening of the accident, and the second vehicle is a vehicle within a predetermined range around the first vehicle when the accident happens.

In the exemplary embodiment, the predetermined time period may be any reasonable time period. For example, it may start from three minutes or one minute before the accident and may end three minutes or one minute after the accident. Also, it may start one minute before the accident and may end two minutes after the accident. The present disclosure does not limit the predetermined time period.

In the exemplary embodiment, the predetermined range may be any reasonable range. The predetermined range includes a location of the first vehicle where the accident happens. For example, the range may be a circular scope which is centered on the location where the accident happens to the first vehicle and have a 20-meter radius. Also for example, the range may be centered on the location where the accident happens to the first vehicle and have a rectangular scope with a length of 20 meters. As another example, the range may be centered on the location where the accident happens to the first vehicle and covers a 20-meter long road. The present disclosure does not limit the predetermined range.

In the exemplary embodiment, the first request may include information of the first vehicle, including the location and a time at which the accident happens to the first vehicle, such that the server can search for a second vehicle and acquire driving record data of the second vehicle as the first video data.

In step 302, the server acquires, as the first video data, driving record data of a second vehicle within a predetermined time period around happening of the accident.

In the exemplary embodiment, the first request may include a search condition for the second vehicle, and the search condition may consist of the information of the first vehicle, including the location and the time at which the accident happens to the first vehicle. Accordingly, the server searches for the second vehicle according to the search condition. In the embodiment, the terminal establishes a communication connection with a car recorder installed in the first vehicle and sends to the server in real time, or within a predetermined period, the information of the first vehicle. The information can be correlated and processed by the server to generate a location log of vehicles. When the server receives the first request, the server searches, from the location log, for a vehicle within the predetermined range around the first vehicle when the accident happens, as the second vehicle.

The server may send to a second terminal corresponding to the second vehicle a second request for acquiring driving record data of the second vehicle within a predetermined time period around happening of the accident. The second terminal corresponding to the second vehicle is a terminal which established a communication connection with a car recorder installed in the second vehicle. In the embodiment, when the terminal corresponding to the first vehicle sends data to the server, an identification of the terminal and an identification of the corresponding first vehicle are also sent to the server. After the second vehicle is identified by the server, the server sends to the second terminal the second request including a start time and an end time of the predetermined time period. After the second terminal receives the second request, the second terminal sends to a car recorder of the second vehicle an acquiring data request including the start time and the end time of the predetermined time period. After the car recorder of the second vehicle receives the acquiring data request, the car recorder of the second vehicle acquires video data collected in the predetermined time period, as the first video data, according to the start time and the end time of the predetermined time period. And the first video data is sent to the second terminal and subsequently is sent by the second terminal to the server. As a result, the server receives the driving record data returned by the second terminal.

In step 303, the server returns the first video data to the first terminal.

It is noted that steps relating to the embodiment in FIG. 3A which are the same as the steps in FIG. 2 are not shown in FIG. 3A or repeated in the above description.

According to the method 300, when the accident happens to the first vehicle, the server acquires, from the second vehicle, driving record data within a predetermined time period around happening of the accident, and sends the driving record data to the terminal corresponding to the first vehicle. Accordingly the terminal corresponding to the first vehicle can obtain additional accident-related video data collected by the car recorder of the second vehicle, thereby increasing effective usage rate of car recorders.

In some embodiments, the method 300 further includes: storing the first video data as accident video data; receiving, as second video data, driving record data of the first vehicle within a predetermined time period around happening of the accident, which is sent by the first terminal; and storing the second video data as accident video data.

Video data relevant to an accident may be important for investigating a cause of the accident. Accordingly, in the embodiments, the driving record data of the first and second vehicles within a predetermined time period around happening of the accident can be stored. For example, the first and second video data as well as information can be stored as the accident video data with a correspondence between them, wherein the information is related to the first vehicle to which the accident happens and includes the location and the time at which the accident happens. Accordingly, it is convenient to obtain accident-related video data when investigating the accident.

In some embodiments, the method 300 further includes: receiving a searching condition of accident video data sent by a terminal; searching for, from pre-stored accident video data, target accident video data matching the searching condition; and returning the target accident video data to the terminal.

In the embodiments, any one of terminals corresponding to different vehicles can request for acquiring accident video data. For example, the terminal can send to the server a request for acquiring accident video data. And this request includes a searching condition of accident video data, including a location or a time at which the accident happens, or an identification of a vehicle corresponding to the terminal and to which the accident happens. After the server receives the searching condition of accident video data, the server searches for, from pre-stored accident video data, target accident video data matching the searching condition. The target accident video data may include the first video data and the second video data, or include one video segment only, or include multiple video segments. The server then returns the target accident video data to the terminal.

It should be noted that, although operations of methods of the present disclosure have been described in a specific order with reference to the drawings, it is not required or suggested that the operations must be performed in the specific order, or it is not required or suggested that all the illustrated operations must be performed to achieve the desired result. Instead, orders for performing the steps illustrated in the flowcharts may be changed. Additionally or alternatively, some steps may be omitted, several steps may be combined into one step for performing, and/or one step may be divided into several steps for performing.

FIG. 3B is a scenario diagram for the above described video data management methods according to an exemplary embodiment. As shown in FIG. 3B, a vehicle 112 hits a vehicle 111 when the vehicle 112 changes its lane in course of driving. This time, a terminal corresponding to the vehicle 111 detects that an accident happens and records information, including a location of the vehicle 111 and a corresponding time at which the accident happens. Subsequently, the terminal corresponding to the vehicle 111 sends to a server a first request including the information which includes the location of the vehicle 111 and the corresponding time.

After the server receives the first request, the server searches for, from a location log, vehicles 112, 113, 114, and 115 within a predetermined range around the vehicle 111 when the accident happens, according to the information received from the terminal corresponding to the vehicle 111. Subsequently, the server sends to terminals corresponding to the vehicles 112, 113, 114, and 115, respectively, a second request to ask for acquiring driving record data of the vehicles 112, 113, 114, and 115 within a predetermined time period around happening of the accident. The second request may include a start time and an end time of a predetermined time period.

After the terminals corresponding to the vehicles 112, 113, 114, and 115 respectively receive the second request, those terminals acquire driving record data of car recorders of the vehicles 112, 113, 114, and 115, respectively, within the predetermined time period around happening of the accident, and send the driving record data to the server.

After the server sends the received driving record data to the terminal corresponding to the vehicle 111, a user of the terminal corresponding to the vehicle 111 can check out the driving record data from the vehicles 112, 113, 114, and 115 within the predetermined time period around happening of the accident to acquire additional accident evidence.

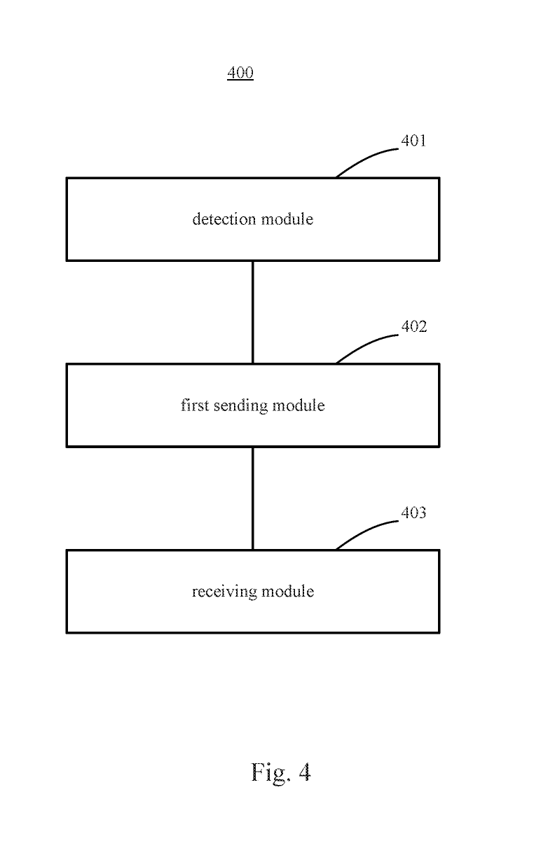

FIG. 4 is a block diagram of an apparatus 400 for managing video data according to an exemplary embodiment. As shown in FIG. 4, the apparatus 400 includes a detection module 401, a first sending module 402, and a receiving module 403.

The detection module 401 is configured to detect whether an accident happens to a first vehicle.

The first sending module 402 is configured to, when it is detected that the accident happens to the first vehicle, send to a server a first request for acquiring first video data, the first video data including driving record data of a second vehicle within a predetermined time period around happening of the accident, the second vehicle being a vehicle within a predetermined range around the first vehicle when the accident happens.

The receiving module 403 is configured to receive the first video data returned from the server.

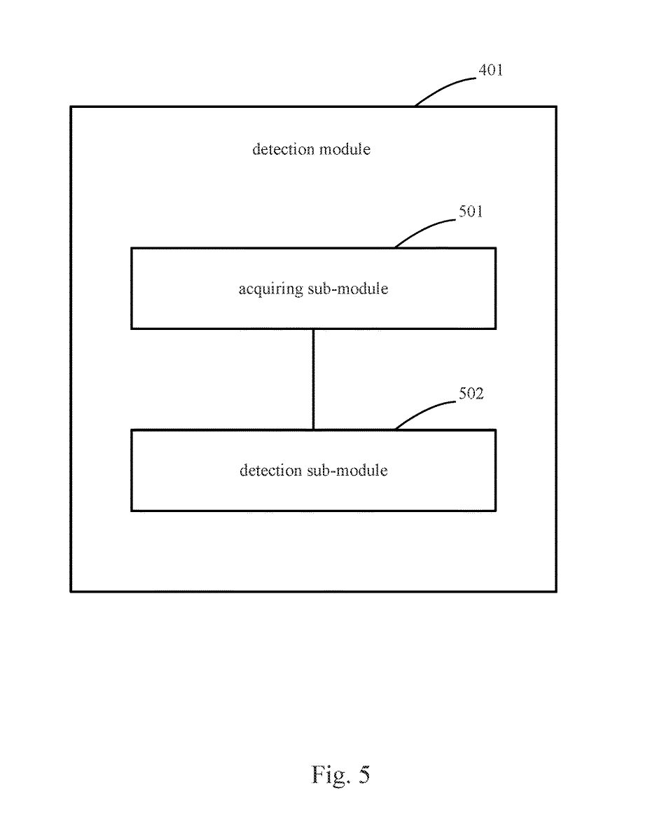

FIG. 5 is a block diagram of the detection module 401 (FIG. 4), according to an exemplary embodiment. As shown in FIG. 5, the detection module 401 includes an acquiring sub-module 501 and a detection sub-module 502.

The acquiring sub-module 501 is configured to acquire driving data of the first vehicle.

The detection sub-module 502 is configured to detect whether an abnormality occurs in the driving data; and if an abnormality occurs in the driving data, determine that the accident happens to the first vehicle.

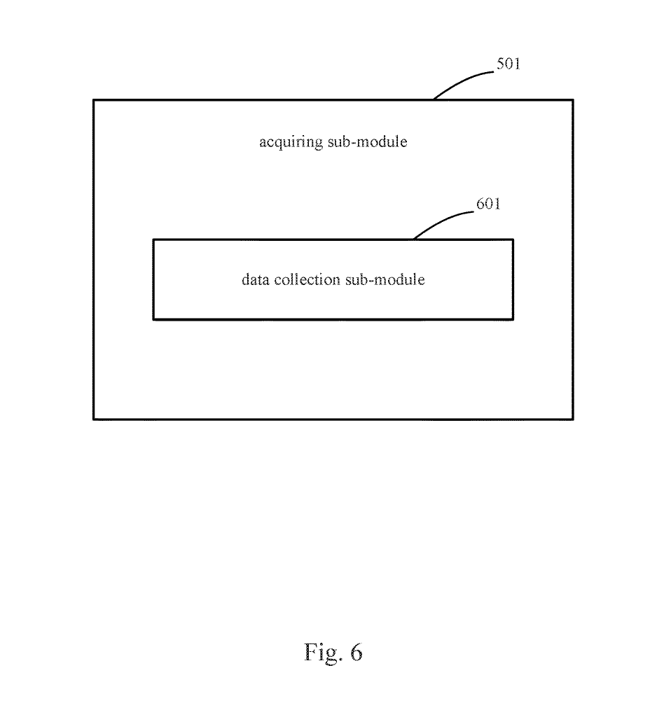

FIG. 6 is a block diagram of the acquiring sub-module 501 (FIG. 5), according to an exemplary embodiment. As shown in FIG. 6, the acquiring sub-module 501 includes a data collection sub-module 601.

The data collection sub-module 601 is configured to acquire data collected by a gyro sensor as the driving data.

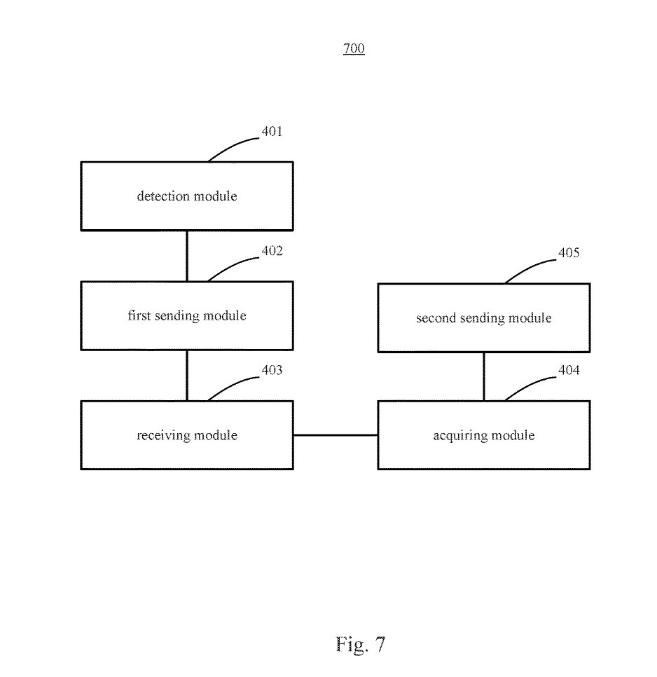

FIG. 7 is a block diagram of an apparatus 700 for managing video data according to another exemplary embodiment. As shown in FIG. 7, the apparatus 700 includes an acquiring module 404 and a second sending module 405, in addition to the detection module 401, the first sending module 402, and the receiving module 403 (FIG. 4).

The acquiring module 404 is configured to acquire, as second video data, driving record data of the first vehicle within a predetermined time period around happening of the accident.

The second sending module 405 is configured to send the second video data to the server to be stored therein.

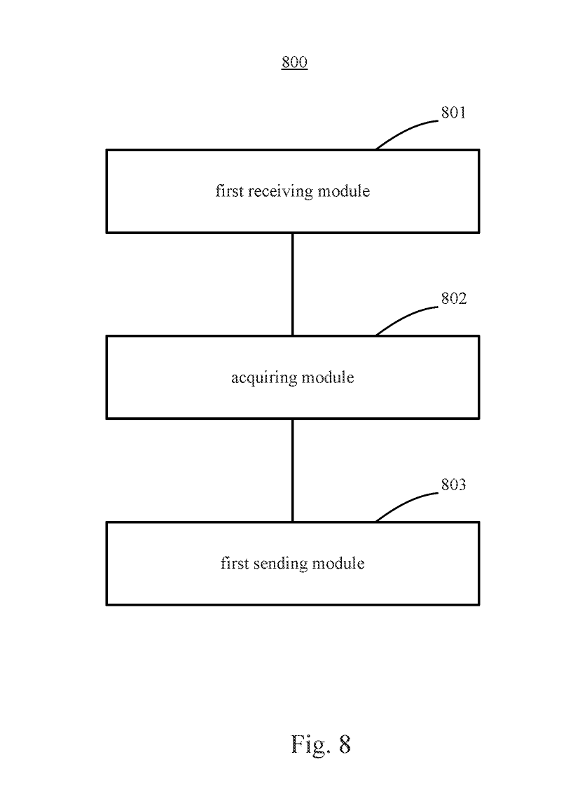

FIG. 8 is a block diagram of an apparatus 800 for managing video data according to another exemplary embodiment. As shown in FIG. 8, the apparatus 800 includes a first receiving module 801, an acquiring module 802, and a first sending module 803.

The first receiving module 801 is configured to receive, from a first terminal corresponding to a first vehicle, a first request for acquiring first video data.

The acquiring module 802 is configured to acquire, as the first video data, driving record data of a second vehicle within a predetermined time period around happening of the accident, the second vehicle being a vehicle within a predetermined range around the first vehicle when the accident happens.

The first sending module 803 is configured to return the first video data to the first terminal.

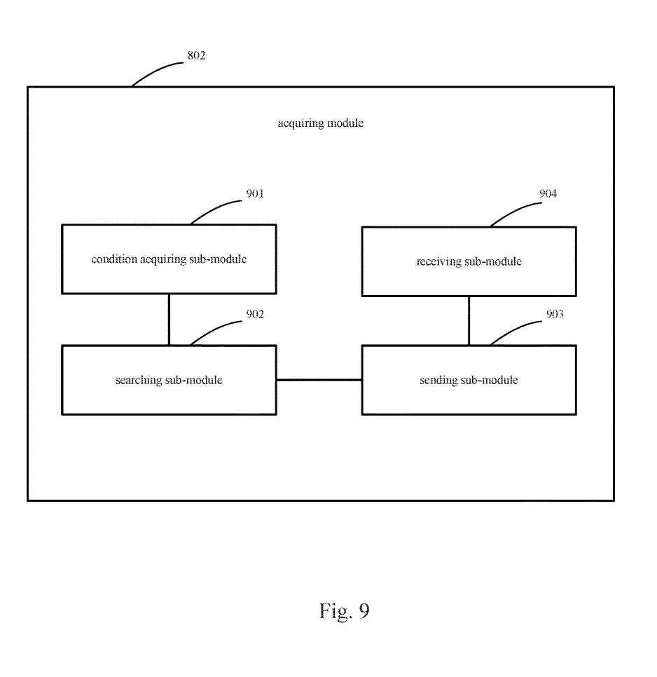

FIG. 9 is a block diagram of the acquiring module 802 (FIG. 8), according to an exemplary embodiment. As shown in FIG. 9, the acquiring module 802 includes a condition acquiring sub-module 901, a searching sub-module 902, a sending sub-module 903, and a receiving sub-module 904.

The condition acquiring sub-module 901 is configured to obtain a search condition from the first request.

The searching sub-module 902 is configured to search for the second vehicle according to the search condition.

The sending sub-module 903 is configured to send to a second terminal corresponding to the second vehicle a second request for acquiring driving record data of the second vehicle within a predetermined time period around happening of the accident.

The receiving sub-module 904 is configured to receive the driving record data returned by the second terminal.

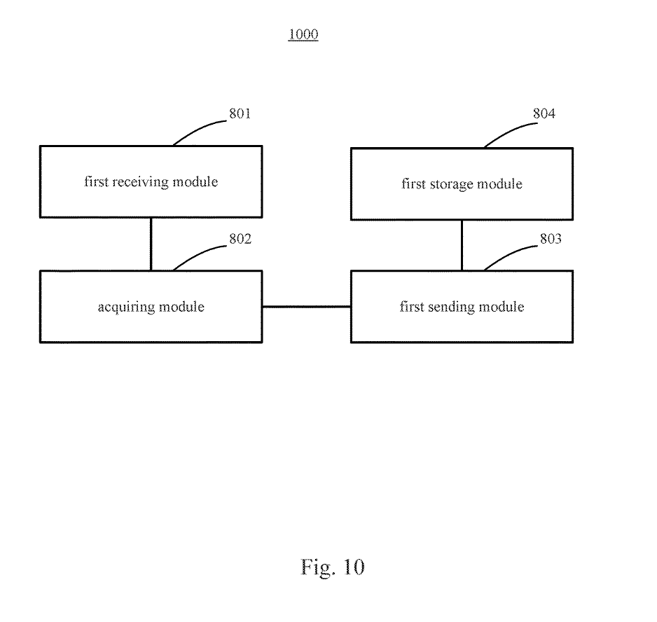

FIG. 10 is a block diagram of an apparatus 1000 for managing video data according to another exemplary embodiment. As shown in FIG. 10, the apparatus 1000 includes a first storage module 804 configured to store the first video data as accident video data, in addition to the first receiving module 801, the acquiring module 802, and the first sending module 803 (FIG. 8).

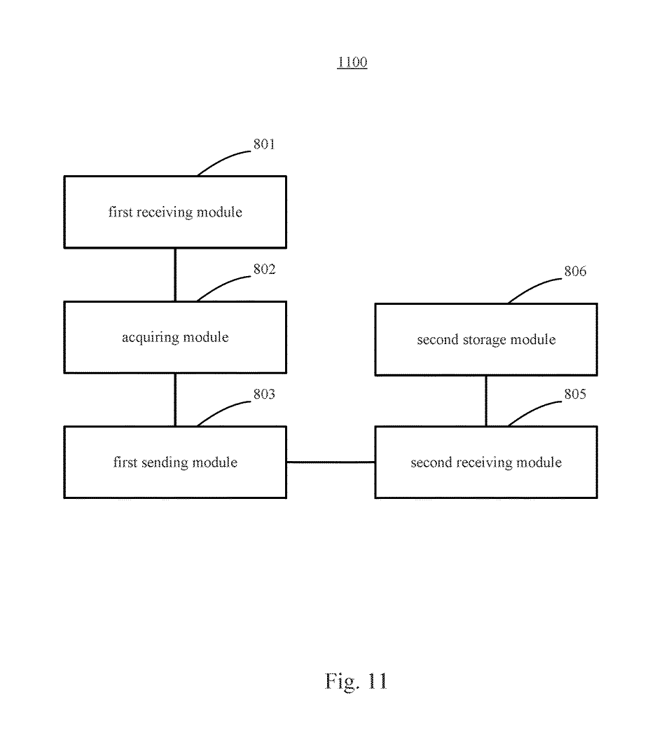

FIG. 11 a block diagram of an apparatus 1100 for managing video data according to another exemplary embodiment. As shown in FIG. 11, the apparatus 1100 includes a second receiving module 805 and a second storage module 806, in addition to the first receiving module 801, the acquiring module 802, and the first sending module 803 (FIG. 8).

The second receiving module 805 is configured to receive, as second video data, driving record data of the first vehicle within a predetermined time period around happening of the accident, which is sent by the first terminal.

The second storage module 806 is configured to store the second video data as accident video data.

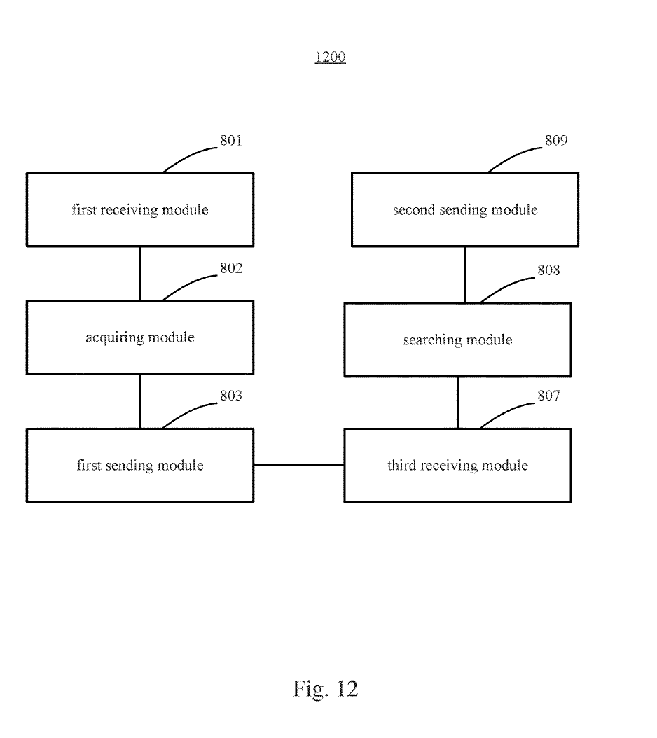

FIG. 12 a block diagram of an apparatus 1200 for managing video data according to another exemplary embodiment. As shown in FIG. 12, the apparatus 1200 includes a third receiving module 807, a searching module 808, and a second sending module 809, in addition to the first receiving module 801, the acquiring module 802, and the first sending module 803 (FIG. 8).

The third receiving module 807 is configured to receive a searching condition of accident video data sent by a terminal.

The searching module 808 is configured to search for, from pre-stored accident video data, target accident video data matching the searching condition.

The second sending module 809 is configured to return the target accident video data to the terminal.

With respect to the apparatus embodiments, since the apparatus embodiments are based on the method embodiments, relevant parts may be referred to the equivalents in the method embodiments. The above-described apparatus embodiments are exemplary only. The modules described as separate components may be or may not be physically independent of each other.

One of ordinary skill in the art will understand that the above described modules can each be implemented by hardware, or software, or a combination of hardware and software. One of ordinary skill in the art will also understand that multiple ones of the above described modules may be combined as one module, and each of the above described modules may be further divided into a plurality of sub-modules.

The present disclosure also provides a terminal which includes: a processor; and a memory for storing instructions executable by the processor. The processor is configured to perform: detecting whether an accident happens to a first vehicle; when it is detected that the accident happens to the first vehicle, sending to a server a first request for acquiring first video data, the first video data including driving record data of a second vehicle within a predetermined time period around happening of the accident, the second vehicle being a vehicle within a predetermined range around the first vehicle when the accident happens; and receiving the first video data returned from the server.

The present disclosure additionally provides a server which includes: a processor; and a memory for storing instructions executable by the processor. The processor is configured to perform: receiving, from a first terminal corresponding to a first vehicle, a first request for acquiring first video data; acquiring, as the first video data, driving record data of a second vehicle within a predetermined time period around happening of the accident, the second vehicle being a vehicle within a predetermined range around the first vehicle when the accident happens; and returning the first video data to the first terminal.

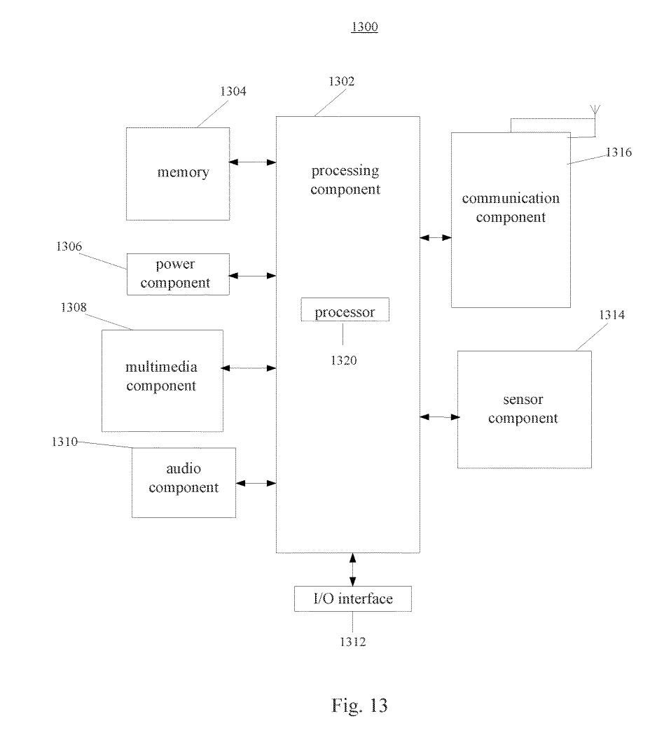

FIG. 13 is a block diagram of an apparatus 1300 for managing video data according to an exemplary embodiment. For example, the apparatus 1300 may be a terminal or a server, such as a mobile phone, a computer, a digital broadcast terminal, a messaging apparatus, a gaming console, a tablet, a medical apparatus, exercise equipment, a personal digital assistant, and the like.

Referring to FIG. 13, the apparatus 1300 may include one or more of the following components: a processing component 1302, a memory 1304, a power component 1306, a multimedia component 1308, an audio component 1310, an input-output (I/O) interface 1312, a sensor component 1314, and a communication component 1316.

The processing component 1302 typically controls overall operations of the apparatus 1300, such as the operations associated with display, telephone calls, data communications, camera operations, and recording operations. The processing component 1302 may include one or more processors 1320 to execute instructions to perform all or a part of the steps in the above-described methods. In addition, the processing component 1302 may include one or more modules which facilitate the interaction between the processing component 1302 and other components. For example, the processing component 1302 may include a multimedia module to facilitate the interaction between the multimedia component 1308 and the processing component 1302.

The memory 1304 is configured to store various types of data to support the operations of the apparatus 1300. Examples of such data include instructions for any application or method operated on the apparatus 1300, contact data, phonebook data, messages, pictures, videos, and the like. The memory 1304 may be implemented using any type of volatile or non-volatile memory apparatuses, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1306 provides power to various components of the apparatus 1300. The power component 1306 may include a power management system, one or more power supplies, and other components associated with the generation, management, and distribution of power in the apparatus 1300.

The multimedia component 1308 includes a screen providing an output interface between the apparatus 1300 and the user. In some embodiments, the screen may include a liquid crystal display (LCD) and a touch panel. If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 1308 includes a front camera and/or a rear camera. The front camera and/or the rear camera may receive external multimedia data while the apparatus 1300 is in an operation mode, such as a photographing mode or a video mode. Each of the front camera and the rear camera may be a fixed optical lens system or have focus and optical zoom capability.

The audio component 1310 is configured to output and/or input audio signals. For example, the audio component 1310 includes a microphone configured to receive an external audio signal when the apparatus 1300 is in an operation mode, such as a call mode, a recording mode, or a voice recognition mode. The received audio signal may be further stored in the memory 1304 or transmitted via the communication component 1316. In some embodiments, the audio component 1310 further includes a speaker to output audio signals.

The I/O interface 1312 provides an interface between the processing component 1302 and a peripheral interface module, such as a keyboard, a click wheel, a button, or the like. The buttons may include, but are not limited to, a home button, a volume button, a starting button and a locking button.

The sensor component 1314 includes one or more sensors to provide status assessments of various aspects of the apparatus 1300. For example, the sensor component 1314 may detect an open/closed status of the apparatus 1300, relative positioning of components, e.g., the display and the keypad, of the apparatus 1300, a change in position of the apparatus 1300 or a component of the apparatus 1300, a presence or absence of user contact with the apparatus 1300, an orientation or an acceleration/deceleration of the apparatus 1300, and a change in temperature of the apparatus 1300. The sensor component 1314 may include a proximity sensor configured to detect the presence of nearby objects without any physical contact. The sensor component 1314 may also include a light sensor, such as a CMOS or CCD image sensor, for use in imaging applications. In some embodiments, the sensor component 1314 may also include an accelerometer sensor, a gyroscope sensor (such as the gyro sensor mentioned above), a magnetic sensor, a pressure sensor, or a temperature sensor.

The communication component 1316 is configured to facilitate communications, wired or wirelessly, between the apparatus 1300 and other apparatuses. The apparatus 1300 may access a wireless network based on a communication standard, such as WiFi, 2G, 3G, or 4G, or a combination thereof. In one exemplary embodiment, the communication component 1316 receives a broadcast signal or broadcast associated notification information from an external broadcast management system via a broadcast channel. In one exemplary embodiment, the communication component 1316 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the apparatus 1300 may be implemented with one or more application specific integrated circuits (ASICs), digital signal processors (DSPs), digital signal processing apparatuses (DSPDs), programmable logic apparatuses (PLDs), field programmable gate arrays (FPGAs), controllers, micro-controllers, microprocessors, or other electronic components, for performing the above-described methods.

In exemplary embodiments, there is also provided a non-transitory computer-readable storage medium including instructions, such as included in the memory 1304, executable by the processor 1320 in the apparatus 1300, for performing the above-described methods. For example, the non-transitory computer-readable storage medium may be a ROM, a random access memory (RAM), a compact disc read-only memory (CD-ROM), a magnetic tape, a floppy disc, an optical data storage apparatus, or the like.

Other embodiments of the present disclosure will be apparent to those skilled in the art from consideration of the specification and practice disclosed herein. This application is intended to cover any variations, uses, or adaptations of the present disclosure following the general principles thereof and including such departures from the present disclosure as coming within common knowledge or customary technical means in the art. It is intended that the specification and embodiments be considered as exemplary only, with a true scope and spirit of the present disclosure being indicated by the appended claims.

It will be appreciated that the present disclosure is not limited to the exact construction that has been described above and illustrated in the accompanying drawings, and that various modifications and changes can be made without departing from the scope thereof. The scope of the present disclosure is only defined by the appended claims.

What is claimed is:

1. A method for managing video data, comprising:
detecting whether an accident happens to a first vehicle;
when it is detected that the accident happens to the first vehicle, sending to a server a first request for acquiring first video data, the first video data being driving record data of a second vehicle within a predetermined time period around happening of the accident, the second vehicle being a vehicle within a predetermined range around the first vehicle when the accident happens; and
receiving the first video data returned from the server.

2. The method according to claim 1, wherein the detecting whether the accident happens to the first vehicle comprises:
acquiring driving data of the first vehicle; and
detecting whether an abnormality occurs in the driving data; and if an abnormality occurs in the driving data determining that the accident happens to the first vehicle.

3. The method according to claim 2, wherein the acquiring driving data of the first vehicle comprises:
acquiring data collected by a gyro sensor as the driving data.

4. The method according to claim 1, further comprising:
acquiring, as second video data, driving record data of the first vehicle within a predetermined time period around happening of the accident; and
sending the second video data to the server to be stored therein.

5. A method for managing video data, comprising:
receiving, from a first terminal corresponding to a first vehicle, a first request for acquiring first video data;
acquiring, as the first video data, driving record data of a second vehicle within a predetermined time period around happening of an accident, the second vehicle being a vehicle within a predetermined range around the first vehicle when the accident happens; and
returning the first video data to the first terminal.

6. The method according to claim 5, wherein the first request includes a search condition for the second vehicle, and the acquiring driving record data of the second vehicle comprises:
obtaining the search condition from the first request;
searching for the second vehicle according to the search condition;
sending, to a second terminal corresponding to the second vehicle, a second request for acquiring driving record data of the second vehicle within the predetermined time period around happening of the accident; and
receiving the driving record data of the second vehicle returned by the second terminal.

7. The method according to claim 5, further comprising:
storing the first video data as accident video data.

8. The method according to claim 7, further comprising:
receiving, as second video data, driving record data of the first vehicle within the predetermined time period around happening of the accident, the second video data being sent by the first terminal; and
storing the second video data as accident video data.

9. The method according to claim 8, further comprising:
receiving a searching condition of accident video data sent by the first terminal;
searching for, from pre-stored accident video data, target accident video data matching the searching condition; and
returning the target accident video data to the first terminal.

10. A terminal, comprising:
a processor;
a memory for storing instructions executable by the processor;
wherein the processor is configured to:
detect whether an accident happens to a first vehicle;
when it is detected that the accident happens to the first vehicle, send to a server a first request for acquiring first video data, the first video data being driving record data of a second vehicle within a predetermined time period around happening of the accident, the second vehicle being a vehicle within a predetermined range around the first vehicle when the accident happens; and
receive the first video data returned from the server.

11. The terminal according to claim 10, wherein the processor is further configured to:
acquire driving data of the first vehicle; and
detect whether an abnormality occurs in the driving data; and if an abnormality occurs in the driving data, determine that the accident happens to the first vehicle.

12. The terminal according to claim 11, wherein the processor is further configured to:
acquire data collected by a gyro sensor as the driving data.

13. The terminal according to claim 10, wherein the processor is further configured to:
acquire, as second video data, driving record data of the first vehicle within a predetermined time period around happening of the accident; and
send the second video data to the server to be stored therein.

14. A server, comprising:
a processor;
a memory for storing instructions executable by the processor;
wherein the processor is configured to:
receive, from a first terminal corresponding to a first vehicle, a first request for acquiring first video data;
acquire, as the first video data, driving record data of a second vehicle within a predetermined time period around happening of the accident, the second vehicle being a vehicle within a predetermined range around the first vehicle when the accident happens; and
return the first video data to the first terminal.

15. The server according to claim 14, wherein the first request includes a search condition of the second vehicle, and the processor is further configured to:
obtain the search condition from the first request;
search for the second vehicle according to the search condition;
send, to a second terminal corresponding to the second vehicle, a second request for acquiring driving record data of the second vehicle within the predetermined time period around happening of the accident; and
receive the driving record data of the second vehicle returned by the second terminal.

16. The server according to claim 14, wherein the processor is further configured to:
store the first video data as accident video data.

17. The server according to claim 16, wherein the processor is further configured to:
receive, as second video data, driving record data of the first vehicle within the predetermined time period around happening of the accident, the second video data being sent by the first terminal; and
storing the second video data as accident video data.

18. The server according to claim 17, wherein the processor is further configured to:
receive a searching condition of accident video data sent by the first terminal;
search for, from pre-stored accident video data, target accident video data matching the searching condition; and
return the target accident video data to the first terminal.
